(19) United States
(12) Patent Application Publication
(10) Pub. No.: US 2023/0210303 A1
(43) Pub. Date: Jul. 6, 2023

(54) SINGLE SERVE COFFEE MAKER

(71) Applicant: Nomi Brew, Inc., Richardson, TX (US)

(72) Inventor: Naomi Masdon, Richardson, TX (US)

(21) Appl. No.: 18/150,335

(22) Filed: Jan. 5, 2023

Related U.S. Application Data
(60) Provisional application No. 63/296,635, filed on Jan. 5, 2022.

(51) Int. Cl. A47J 31/52; A47J 31/42; A47J 31/46; A47J 31/54; A47J 31/08; A23F 5/08; A23F 5/26; B65D 85/804

(52) U.S. Cl. CPC A47J 31/5253; A47J 31/42; A47J 31/468; A47J 31/461; A47J 31/54; A47J 31/08; A23F 5/08; A23F 5/262; B65D 85/8061

(57) ABSTRACT

A single serve coffee brewer includes a user input device configured to receive brew information from a user. A grinding mechanism grinds whole coffee beans based on the brew information. A brew chamber includes a first section to receive and retain the ground coffee beans, a filter divider retaining the ground coffee beans in the first section, and an annular section prevented from receiving the ground coffee beans by the filter divider. A water reservoir and a heater configured to heat water from the reservoir based on the brew information. A water pump moves a measured amount of heated water from the heater to the brew chamber, based on the brew information. A drawdown release valve retains the water in the brew chamber for a set duration, based on the brew information, and releases brewed coffee from the brewing chamber responsive to the duration elapsing.

### RELATED APPLICATION

The present application claims the benefit of priority to U.S. Patent App. No. 63/296,635, filed Jan. 5, 2022, which is hereby incorporated in its entirety.

### FIELD OF DISCLOSURE

The present disclosure generally relates to coffee makers, and more particularly to single-serve coffee brewers.

### BACKGROUND

Single-serve coffee makers provide ease and simplicity to brewing a cup of coffee. Single-use coffee “pods” allow for a fast and convenient brew process, but the pods are generally difficult to recycle or compost. Additionally, while a relatively small amount of coffee grounds are used to brew a single cup of coffee, the pod packaging tends to be relatively large in comparison to the size of the grounds. This results in a waste of additional materials that are difficult to recycle. Moreover, the coffee used for the pods is pre-ground and may be of relatively poor quality, producing an inferior-tasting drink.

Pour-over and immersion-style coffee makers allow for single serve brewing, but are generally more difficult to use. For example, in the case of an immersion-style brewer, the brew process must be manually timed, and action is required on the part of the user when the brew is complete to prevent over-extraction of the compounds in the coffee beans, leading to off flavors and an inferior-tasting drink. As another example, pour-over style coffee makers require additional equipment, in the form of a special “goose neck” style kettle. Additionally, a certain degree of manual dexterity is required to produce a cup of coffee using a pour-over brewing method.

Accordingly, there is a need for an easy to use, high-quality coffee experience that does not require timed interaction on the part of the user, and does not require increased manual dexterity in the brewing process.

### BRIEF OVERVIEW

A single serve coffee brewer may be provided. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The single serve coffee brewer delivers a quality single-serve cup of coffee from unground bean to brew. To begin the brew process, a user may select a brew packet, comprising a pre-measured amount of whole coffee beans in a compostable package that also serves as a coffee filter. The package-as-filter is designed to offer the user a simpler single-use model that has a dual purpose, no waste (all compostable), and a better experience in the coffee-making process.

The compostable paper filter contains a pre-measured bean amount needed to brew a single cup of 8-12 oz coffee. The user can tear the packet open (e.g., along a perforated edge) to open the package. The beans can be placed into a hopper that conveys the beans to a grinder, and the package-(now-serving as a filter) can be inserted into a brew cone and installed into a brew chamber of the single serve coffee brewer.

Alternatively, the user may insert a filter, such as a paper filter or a reusable filter into the brew cone. The filter may be a miniature filter, designed to retain ground coffee for a single serving of coffee, or may be a standard-sized coffee filter, such as a No. 4 filter, as is known in the art. The user may measure an amount of coffee beans from a larger container (e.g., a multi-use container of whole coffee beans) for grinding by the coffee maker. The measured beans may be placed into the hopper as described above, to be conveyed to the grinder.

The user can select various brew properties, including, for example, a brew size (e.g., 8-12 oz), a desired temperature (e.g., normal/hot/hotter), and a desired brew strength (e.g., corresponding to a duration of brew immersion time). The brewer activates the grinder, causing the whole coffee beans to move from the hopper to the grinder, where the beans are ground. Once ground, the beans are delivered to the filter inside the immersion brew cone. After all beans have been ground, water is pumped from a reservoir and heated to the desired temperature. The hot water is then introduced into the brew chamber, through the immersion brew cone. As the immersion brew cone fills, the water swirls and agitates the grounds to fully pre-wet and then immerse the coffee to brew it for the desired amount of time.

Once the brewing process is complete the user can easily remove the immersion brew cone from the device, and remove the spent coffee and filter to compost the spent coffee and/or the filter, then replace it with another. If the user has used a reusable filter, the reusable filter may be washed to prepare the filter for reuse.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of a single serve coffee brewer consistent with the present disclosure;

FIG. 2 shows a perspective view of a particular embodiment of the single serve coffee brewer;

FIG. 3 shows another perspective view of the particular embodiment of the single serve coffee brewer;

FIG. 4 shows a front elevation of the particular embodiment of the single serve coffee brewer;

FIG. 5 shows a rear elevation of the particular embodiment of the single serve coffee brewer;

FIG. 6 shows a right-side elevation of the particular embodiment of the single serve coffee brewer;

FIG. 7 shows a left side elevation of the particular embodiment of the single serve coffee brewer;

FIG. 8 shows a top view of the particular embodiment of the single serve coffee brewer;

FIG. 9 shows a bottom view of the particular embodiment of the single serve coffee brewer; and

FIG. 10 is a flow chart of a method for using the single serve brewer.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

### I. PLATFORM OVERVIEW

Consistent with embodiments of the present disclosure, a single serve coffee brewer may be provided. This overview is provided to introduce a selection of concepts in a simplified form that are further described below. This overview is not intended to identify key features or essential features of the claimed subject matter. Nor is this overview intended to be used to limit the claimed subject matter's scope.

The single serve coffee brewer may deliver a quality single-serve cup of coffee, from unground bean to brew.

Whole (e.g., unground) beans may be provided for the single serve coffee brewer. In embodiments, the whole beans may be provided in a package, and the package that contains the beans may be usable as a filter for brewing the coffee. The package-as-filter may offer a simpler single-use model that has a dual purpose, minimal (e.g., no) waste, and a better experience in the coffee-making process. In embodiments the package may be made from a compostable material, such as paper.

The retail packaging for the coffee beans may be formed from a paper filter, and may contain a pre-measured amount of whole coffee beans suitable to be used to brew a single cup (e.g., on the order of 6-12 ounces) of coffee. The packaging may have a removable edge (e.g., a perforated edge) at which the packaging can be opened, preserving a large enough portion of the packaging for use as a filter. Once opened, the whole beans may be evacuated from the packaging into a hopper or other container for introduction to a grinding apparatus. To be used as a filter, the packaging may be inserted into an immersion brew cone. The immersion brew cone may be installed into a brew chamber of the single serve brewer. Once inserted, the packaging may act as a filter divider, dividing the brew cone into a first conical section that receives the ground coffee for steeping and a second annular section that surrounds the first conical section and allows for water flow throughout the brew chamber. In particular the packaging may be formed from a porous material (e.g., filter paper) that allows the water to pass therethrough, but prevents passage of the ground coffee beans through the filter.

The user can select various brew properties. For example, selectable brew properties may include a brew size (e.g., from 6 to 12 oz), a brew temperature (e.g., using qualitative selections such as normal/hot/hotter, and/or quantitative selections such as 195° F., 200° F., 205° F.), and/or a brew strength (e.g., using qualitative selections such as normal/strong/stronger, and/or quantitative selections of a duration of brew immersion time) may be selected. In some embodiments, the user may also select a grind size (e.g., qualitative selections such as coarse/regular/fine. quantitative selections, such as 1 mm, 0.75 mm, 0.5 mm). In some embodiments, each type of coffee roast may have a preset standard or recommended list of brew properties for a recommended brew.

Upon activation, the single serve coffee brewer may grind the beans using a grinding mechanism (e.g., conical burr grinder, flat burr grinder, blade grinder, or the like). The ground beans may be evacuated from the grinding mechanism to the filter installed in the brew chamber. For example, the ground coffee may be evacuated into the filter via a chute, or may be expelled directly from the grinder into the filter.

Upon completion of grinding the beans and loading the filter, water may be pumped into the brew chamber. For example, the water may be pumped from a reservoir or other tank, or may be allowed to flow through a line connected to a water main. In embodiments, the water is heated prior to being introduced to the brew chamber. The water may be heated using, for example, a flash heating unit configured to raise the water to the specified brewing temperature. In some embodiments, the water may be introduced to the brew chamber via the chute, downstream of the grinding mechanism. This positioning may allow the water to flush any remaining coffee grounds and/or dust (chaff) from the chute into the filter. In other embodiments, the water may be pumped directly into the brew chamber. As the brew chamber fills with water, the water may swirl and/or agitate the ground coffee beans to pre-wet and immerse the coffee. The water may remain in the brewing chamber for an amount of time specified by the brew strength or brew duration.

Responsive to the specified amount of time elapsing, the brewing process is complete. The water can be released from the brew chamber in a drawdown process. For example, a solenoid-based stopper may be actuated to allow water to flow downward out of the brew chamber and into a coffee mug or other container. In some embodiments, the solenoid-based stopper may be electromechanically activated (e.g., by a controller or processor). In other embodiments, the solenoid-based stopper may be otherwise mechanically activated. Once the drawdown process is complete, a user may remove the immersion brew cone from the device, and remove the ground coffee and filter from the immersion brew cone. The ground coffee and filter may be composted or otherwise discarded.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

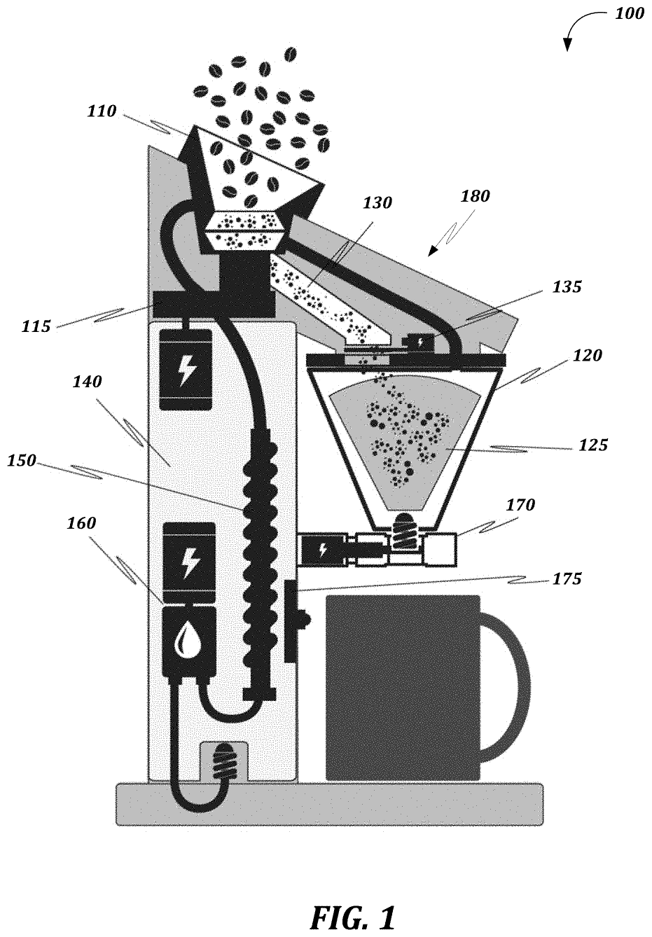

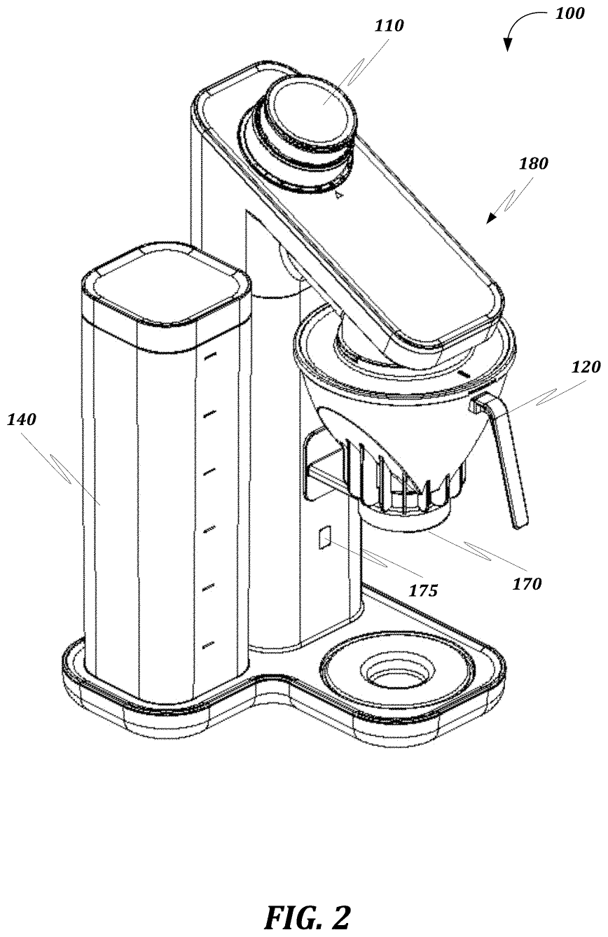

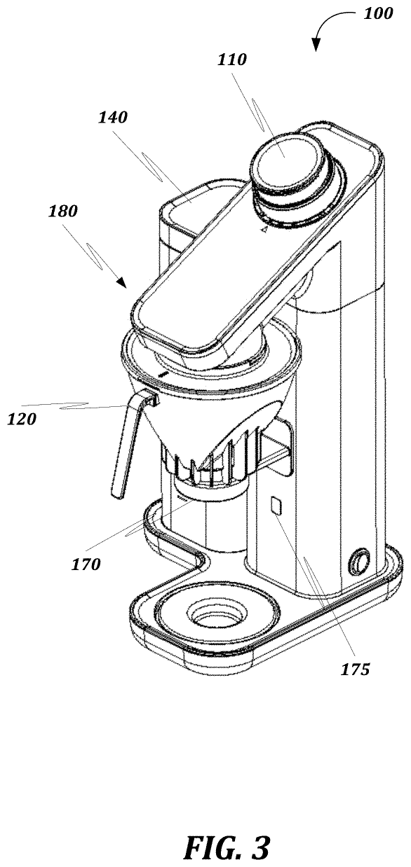

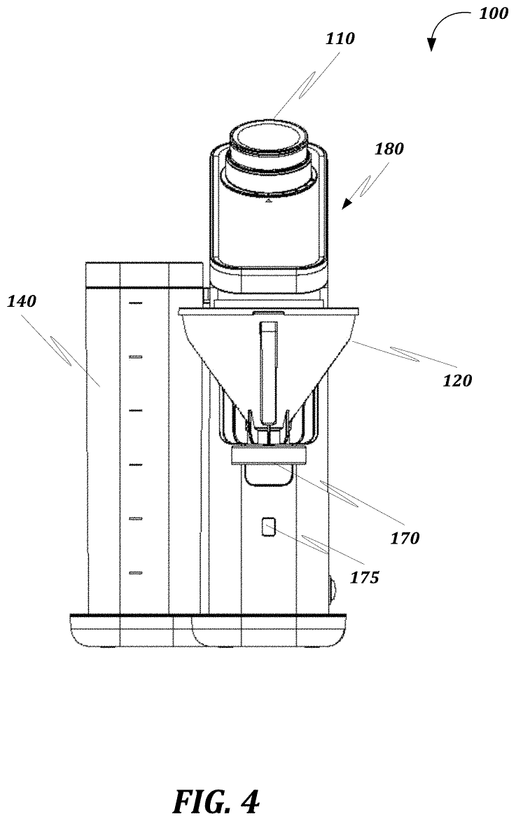

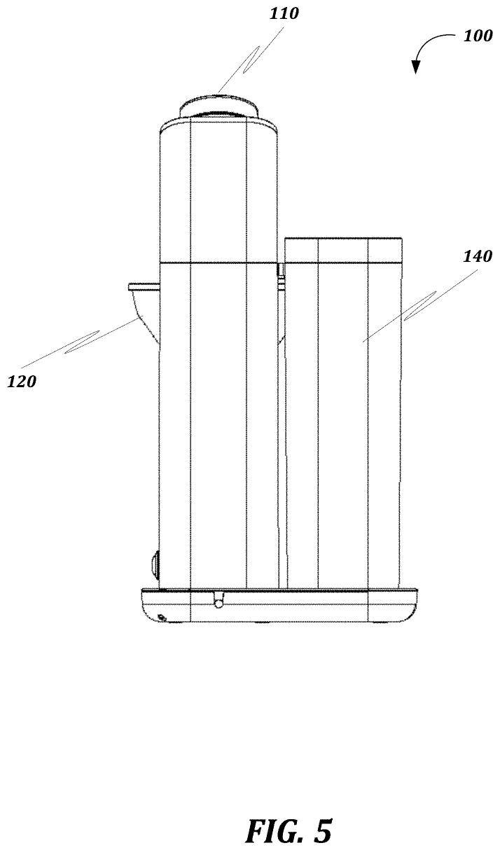

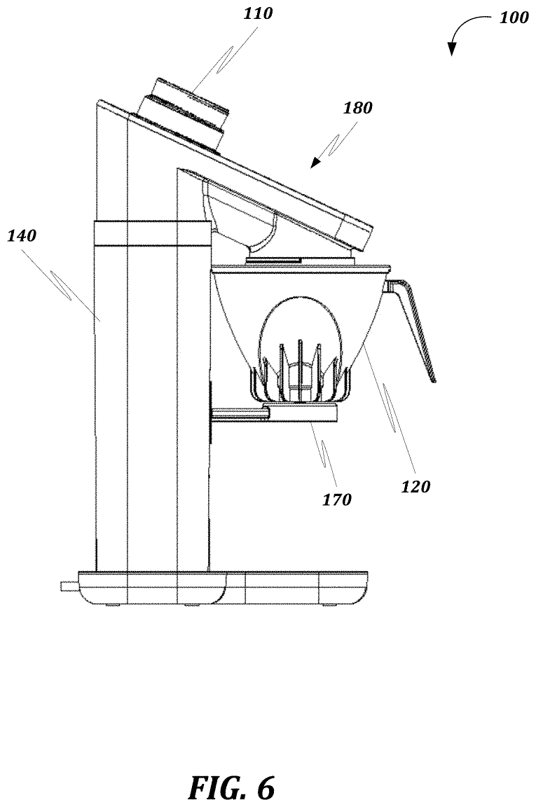

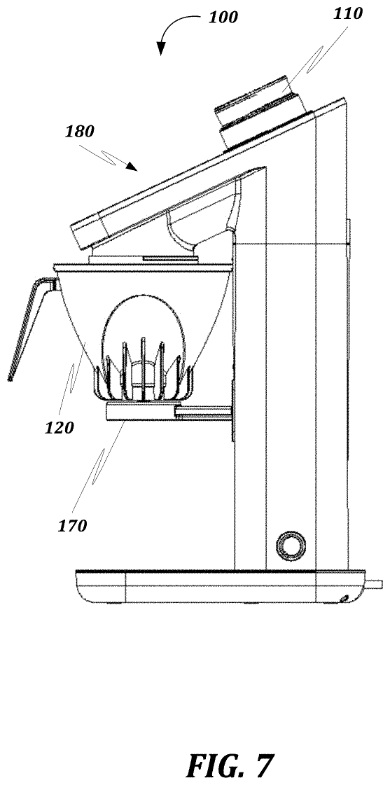

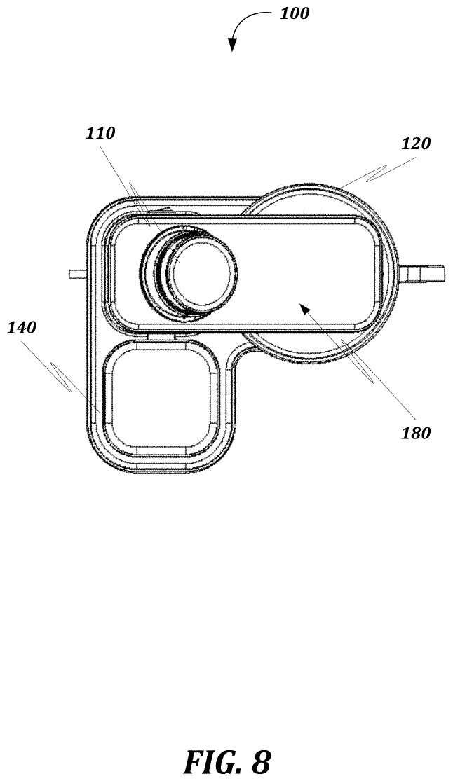

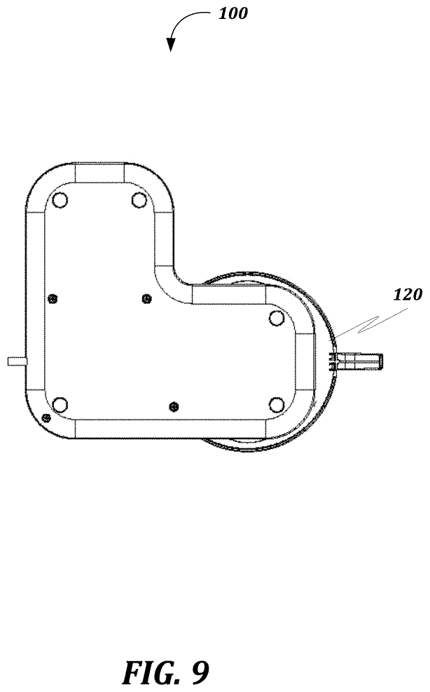

FIG. 1 illustrates a cutaway view showing one possible configuration of a single serve coffee brewer 100. FIGS. 2-9 illustrate various views of the exterior of the single serve coffee brewer 100. As shown in FIGS. 1-9, the single serve brewer 100 may include various components, including a grinding mechanism 110, a brew chamber 120, and a passage 130 connecting the grinding mechanism and the brew chamber 120. The single serve brewer 100 may include a water source 140, a heater 150, a pump 160, and a drawdown release valve 170. The single serve brewer 100 may include a user input/output panel 180 and a processing device (not shown).

As shown in FIG. 1, the grinding mechanism 110 may be formed as a blade grinder, a conical burr grinder, a flat burr grinder, and/or other suitable mechanism for grinding whole dried coffee beans into relatively fine particles. The grinding mechanism 110 may be configured to receive whole coffee beans and to grind the coffee beans. In embodiments, the grinding mechanism may be configured to grind the beans to one or more different grind sizes. As an example, the grinding mechanism 110 may include a motor and gear assembly 115 configured to operate the grinding mechanism/

In some embodiments, the grinding mechanism 110 may be a blade grinder. A blade grinder includes a receptacle into which the coffee beans may be placed (e.g., from the filter packaging) and a spinning blade (e.g., operated by the motor and gear assembly 115) disposed within the receptacle. The spinning blade may be configured to slice or chop the coffee beans into a powder. In embodiments, the blade grinder may be configured to chop beans to different sizes based on, for example, the blade spinning for different lengths of time. That is, a blade spinning for a shorter length of time may produce large grind sizes, while a blade spinning for a longer time may produce finer grind sizes.

In some embodiments, the grinding mechanism 110 may be a conical burr grinder. A conical burr grinder typically includes two burrs, having facing sides formed from an abrasive substance. The two facing sides are generally shaped as conical frustums. An adjustable gap between the two facing sides generally allows for control of a particle size produced by the conical burr grinder. Conical burr grinders work by crushing the coffee beans between the burrs (e.g., by rotating one burr relative to the other using the motor and gear assembly 115), resulting in a consistent particle size. The coffee beans are introduced at a top side of the conical burr grinder, and the particles fall through a bottom side of the burr grinder when the particle is small enough to fit through the gap. The conical burr grinder may adjust grind size by adjusting the space between the burrs.

In some embodiments, the grinding mechanism 110 may be a flat burr grinder. A flat burr grinder works in generally the same way as a conical burr grinder. However, a flat burr grinder has generally flat annular burrs. The beans are drawn in between the two burrs and crushed into a uniform size. The flat burr grinder may adjust grind size by adjusting the space between the burrs.

The single serve brewer 100 may include a brew chamber 120. In embodiments, the brew chamber 120 may be a generally conical chamber, having a wide top opening and a narrow bottom opening. In some embodiments, the top opening and the bottom opening can each be approximately circular, producing a round brew cone. In some embodiments, the top opening and the bottom opening can each be polygonal (e.g., hexagonal, octagonal), producing a helix-type brew cone. In yet other embodiments, the top opening and the bottom opening may each have different shapes. The brew chamber 120 may be formed from a durable, non-reactive material, such as plastic, glass, stainless steel, or porcelain. The brew chamber 120 may be removably attached to the single serve coffee brewer 100. For example, the brew chamber 120 may attach to the single serve coffee brewer using magnets, a threaded attachment, a friction fit, and/or the like.

The brew chamber 120 may be configured to retain ground coffee beans and hot water, and to facilitate brewing of coffee within the brew chamber. In particular, the brew chamber may be insulated

In some embodiments, the brew chamber 120 may include filter 125 that is removably disposed within the brew chamber 120. In embodiments, the filter 125 may be formed from a porous material that retains ground coffee while allowing water to pass therethrough, promoting proper brewing of coffee. In some embodiments, the filter 125 may be a miniature filter, suitable for brewing a single serving of coffee. In other embodiments, the filter 125 may be a standard sized coffee filter, such as (but not limited to) a No. 4 filter. In embodiments, the filter 125 may include a carrier basket formed from a relatively rigid, heat-proof, and non-reactive material, such as plastic. In some embodiments, the carrier basket may be configured to receive and retain the filter 125 (e.g., the package-as-filter discussed above, a disposable paper filter, a reusable filter, etc.) for filtering coffee grounds. Alternatively, the carrier basket may include an integrated reusable filter 125, such as a mesh filter. The carrier basket may define one or more apertures to allow for fluid flow through the walls of the carrier basket.

In some embodiments, the brew chamber 120 may be sized to receive a standard sized coffee filter. For example, the brew chamber may be sized to receive a standard #4 sized filter.

In embodiments, a chute or passage 130 connects the grinding mechanism 110 to the brew chamber 120. In embodiments, the passage 130 may be an angled, elongate tunnel, having a first end connected to the grinding mechanism 110 disposed relatively higher than a second end connected to the brew chamber 120. The angle of the passage 130 may be selected such that gravity causes material (e.g., ground coffee beans, water) deposited into the passage to flow downward toward the second end of the passage 130 and into the brew chamber 120. In some embodiments, the passage 130 may be formed from and/or coated with a static dissipative material. The static dissipative material may help to prevent a buildup of static electricity and reduce clinging of electrically charged particles (e.g., coffee grounds) to the surfaces of the passage 130.

In some embodiments, a motorized door 135 may selectively block passage of material (e.g., ground coffee and/or water) between the chute 130 and the brew chamber 120. For example, the motorized door 135 may allow for the chute to be substantially filled with water to remove ground coffee and/or chaff from the chute. In embodiments, the motorized door may be controlled using an electric motor, a solenoid, a gear mechanism, and/or any other electrical or mechanical means of sliding and/or otherwise opening the door. The door may be biased (e.g., by a spring or other biasing mechanism) such that the door is normally closed, and is opened upon activation of the electrical or mechanical motor.

The single serve brewer 100 may include a water source 140. In some embodiments, as best shown in FIGS. 1-6, the water source 140 may include a reservoir or other tank for retaining water. The reservoir may have a size that is at least sufficient to a single cup of coffee (e.g., at least 12 ounces). However, those of skill will recognize that the reservoir may be arbitrarily large. In some embodiments, a reservoir size may be selected to strike a balance between ease of use (not requiring a user to refill the reservoir too often) and bulk added to the brewer 100. As a particular example, a reservoir may have a size in the range of approximately 40-60 ounces. In some embodiments, the water source 140 may comprise a connection to a home water line or other water main.

In embodiments, as best shown in FIG. 1, the single serve brewer 100 may include a heater 150. The heater 150 may be used to heat the water to a brewing temperature (e.g., in the range of 190° F-210° F.). In some embodiments, the heater 150 may comprise a water reservoir, supplemental to the water source 140 and a heating element configured to heat the water in the reservoir to the brewing temperature. Alternatively, the heater 150 may be a flash heater or tankless water heater configured to heat the water on demand as the water passes through the heater. The flash water heater 150 may include a water feed tube that is surrounded by a heating element configured to heat water passing through the feed tube to the brewing temperature.

The single serve brewer 100 may include a pump 160, as shown in FIG. 1. The pump 160 may be configured to move liquid (e.g., water) from the water source 140 to the brew chamber 120. In embodiments, the pump 160 may use piping to carry the water from the water source 140 to the heater 150, and from the heater 150 to the brew chamber 120. In embodiments, the liquid may be deposited directly into the brew chamber 120. Alternatively, at least a portion of the liquid may be pumped into the passage 130. The liquid may help to remove ground coffee and/or coffee chaff from the passage 130, and/or may help to reduce static electricity in the passage.

In some embodiments, pumping the liquid may comprise pumping a first amount of liquid onto the grounds, and then subsequently pumping a second amount of liquid into the brew chamber 120. The first amount of liquid may be an amount sufficient to bloom the ground coffee beans. For example, the first amount of water may weigh approximately twice the weight of the ground coffee. The first amount of water may be sufficient to wet the ground coffee and to interact with the coffee, allowing for escape of carbon dioxide gas bubbles. Thereafter, the pump may move the second amount of water to the brew chamber for brewing the coffee. The second amount of water may be determined based on, for example, one or more of the desired brew size and the volume of the first amount of water.

The single serve brewer 100 may include a drawdown release valve 170, as shown in FIG. 1. The drawdown release valve 170 may be disposed at the small end of the brew chamber 120. The drawdown release valve 170, when in a closed position, forms a watertight seal with the walls of the brew chamber 120, preventing water from leaving the brew chamber during a brew process. The drawdown release valve 170 may be operated via an electric motor, a solenoid, a gear mechanism, and/or any other electrical or mechanical means of moving the release valve from the closed position to an open position upon a brew timer elapsing. The drawdown release valve 170, when in an open position, allows brewed coffee to flow out from the brew chamber 120 and into a mug or other receptacle. The flow of coffee from the brew chamber 120 to the mug is known as “drawdown.”

In at least some embodiments, the brewer 100 may include a sensor 175 for determining whether a cup (e.g., a coffee mug, travel mug, or the like) is positioned below the drawdown release valve 170 to receive coffee upon completion of the brew process and opening of the drawdown release valve. For example, the sensor 175 may include an infrared sensor for detecting object presence, as shown in FIG. 1. Alternatively or additionally, the sensor 175 may include a contact sensor or switch in a base of the brewer 100 and/or any other means of sensing presence of the cup. If the presence of the cup is not detected by the sensor 175, the sensor may prevent the drawdown release valve 170 from opening, thereby stopping flow of coffee.

As shown in FIG. 1, the filter 125 divides the brew chamber into a first (generally conical) portion, inside both the carrier basket and the brew chamber, and a second (generally annular) portion, disposed inside the brew chamber, but external to the carrier basket. The first section brews in a manner similar to typical immersion brewing, where the coffee and water are in contact for the entire brew time, allowing for increased extraction of compounds from the coffee. The second section brews in a manner similar to drip coffee, where the water passes through the coffee, extracting compounds, and then separates from the grounds. During drawdown, the water can again flow through the coffee grounds and through the drawdown release valve 170.

The single serve brewer 100 may include a user input/output panel 180. In embodiments, the user input/output panel 180 may include one or more input controls allowing a user to provide input. For example, the user input controls may include one or more buttons, one or more dials, one or more slides, one or more switches, and/or the like. Additionally or alternatively, the user input controls may include a touch-sensitive screen for receiving touch input from a user. In some embodiments, the one or more user input devices may include a camera and/or a keypad (e.g., a number pad or full keyboard). In embodiments, the user input/output panel 180 may include one or more output devices for providing output to a user. For example, the one or more output devices may include one or more lights (e.g., light bulbs, light emitting diodes, etc.), one or more buzzers, one or more speakers, and the like. Additionally, or alternatively, the one or more output devices may include one or more display screens. For example, the one or more output devices may include a liquid crystal display, a plasma display, and/or an e-ink display.

In embodiments, the user input/output panel 180 may be used to communicate data regarding properties of the brewing process. For example, the user can select brewing properties for use in the brewing process. As particular examples, the brewing properties may include settings for water temperature, brew size, brew strength/duration, and/or a grind size. In some embodiments, the user may set the brewing properties based on personal preferences. Additionally or alternatively, the user may enter a code (e.g., by scanning a QR code, using a keypad, etc.) associated with a particular type of coffee to be brewed, and the single serve brewer 100 may determine brew properties that result in the best brew for the particular type of coffee.

In embodiments, the user may provide an indication of desired brew properties using the input/output panel 180. As examples, the provided brew properties may include an indication of a grind size, an indication of a brewing temperature, an indication of a brewing duration, and/or an indication of a brew size. The indications provided by the user may include more, fewer, or different indications of brew properties without departing from the scope of this invention.

In some embodiments, the brew properties may include a delayed start timer. For example, a user may set a brew to begin after a particular amount of time elapses (e.g., begin brewing in 8 hours) and/or at a particular time of day (e.g., begin brewing at 7:30 AM). The user may use the various user input controls to set the brewing properties. The various output devices may be used to provide feedback regarding the brewing properties.

The single serve brewer 100 may include a processing device (not shown). In embodiments, the processing device may receive, as inputs, data from the user input/output panel 180. Based at least in part on the received data, the processing device may control one or more of the grinding mechanism 110, the heater 150, the pump 160, the drawdown release valve 170, and/or the user input/output panel 180. The processing device may be, for example, a processor, microprocessor, field programmable gate array, or other device. For example, the processing device may determine brew information including one or more of a grind size, a brewing temperature, a brewing duration, or a brew size based at least in part on one or more inputs received via the user input/output panel 180.

### III. PLATFORM OPERATION

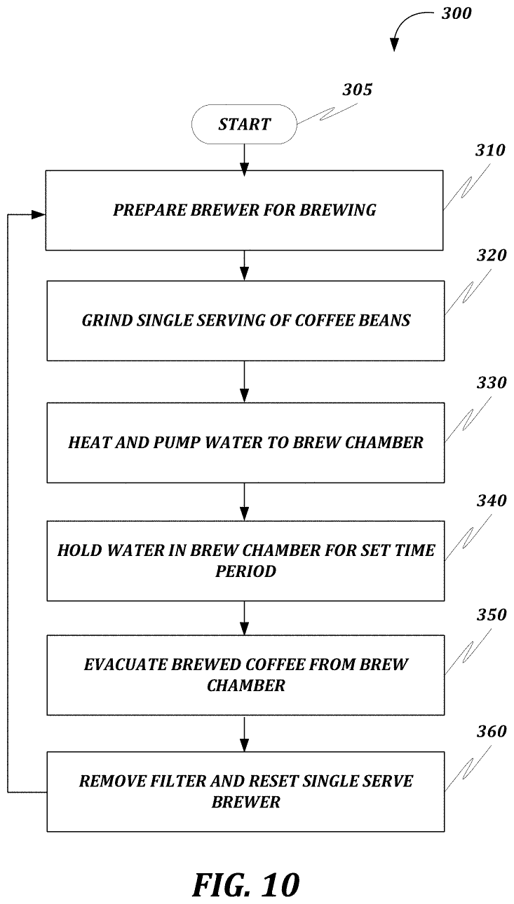

FIG. 10 is a flow chart setting forth the general stages involved in a method 300 for brewing coffee using the single serve brewer 100. Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of method 300 will be described in greater detail below.

Method 300 may begin at starting block 305 and proceed to stage 310 where a user may prepare the single serve brewer for brewing. In embodiments, preparing the single serve brewer may include maintenance and marshalling resources for the single serve brewer (e.g., ensuring that the brewer has a sufficient supply of water, depositing whole coffee beans for grinding, inserting a coffee filter, ensuring that the brew chamber is attached to the brewer, etc.), and receiving brewing properties from the user.

Preparing the single serve brewer may include, for example, ensuring that the brewer is in working condition and is powered. As discussed above, marshalling resources for the single serve brewer may include providing water for the brewer, depositing coffee beans, and inserting a filter. Providing water may include ensuring that the brewer is connected to a water line and/or ensuring that a water reservoir has a sufficient amount of water to brew a single serving of coffee. Depositing coffee beans into a grinding mechanism of a single serve coffee brewer may include depositing beans from a retail package that includes only the single serving of coffee beans, or measuring and depositing an amount of coffee beans from a larger container (e.g., a multi-use container of whole coffee beans) for grinding by the coffee maker. Inserting a coffee filter may include, for example, installing a filter (e.g., a package-as-filter as discussed above. A single use filter, or a reusable filter) into the brew chamber (e.g., into a carrier basket that is installed into the brew chamber).

Receiving brewing properties from the user may include receiving properties entered directly by the user. In some embodiments, receiving brewing properties from the user may include receiving an indication of a type of coffee (e.g., a particular roast, a particular origin, etc.) and determining brewing properties based on the indication. For example, the system may determine one or more brewing properties (e.g., water temperature, brew size, brew strength/duration, and/or a grind size) based on a provided indication of a coffee type. Alternatively, a user may specify one or more of the brewing properties directly, e.g., using an input mechanism.

In some embodiments, receiving brewing properties may include receiving a delayed brewing trigger. For example, the delayed brewing trigger may include a time duration to wait before brewing, a future time at which to begin brewing, and/or any other indicator of a brewing to occur in the future. Alternatively, the brewing properties may include a request to begin brewing.

Returning now to FIG. 10, after preparing for the brew process in stage 310, the method 300 may proceed to stage 320, where the single serve coffee brewer may grind the single serving of coffee beans. The brewer may determine, based at least in part on input received in stage 310, a grind size to be used. The brewer may cause a grinding mechanism to be set appropriately based on the specified grind size. For example, if the grinding mechanism is a burr grinder (e.g., a conical burr grinder or flat burr grinder), a processing unit within the single serve brewer may issue one or more instructions causing the burr grinder to adjust a grind size based on the specified grind size; if the grinding mechanism is a blade grinder, the processing unit may issue one or more instructions adjusting a blade spinning duration. The processing unit may issue one or more instructions causing the grinding mechanism to grind the beans. After grinding, the ground coffee beans fall into the filter positioned in the brew chamber.

Following grinding the beans in stage 320, the method 300 may proceed to stage 330, where the single serve brewer may heat and pump the water to the brew chamber.

In some embodiments (e.g., where the heater includes a tank for retaining and heating water), the single serve brewer can cause a pump to move water from a water source to the tank. The single serve brewer may determine a brew temperature specified in stage 310. The single serve brewer may cause the heater to heat the water in the tank to a particular temperature based on the specified brew temperature.

In other embodiments (e.g., where the heater is a tankless flash heater), the single serve brewer may cause the flash heater to heat water that passes therethrough to a particular temperature based on the specified brew temperature. The pump can draw water through the heater to bring the water to the particular temperature.

Thereafter, at least a portion of the heated water can be pumped such that the water enters a brew chamber. In some embodiment, the heated water may be pumped to one or more insertion positions and/or may enter the brew chamber from one or more directions for proper immersion of the ground coffee beans within the water. A first insertion point may be disposed in the passage between the grinding mechanism and the brew chamber. Pumping water to the first insertion point may help to clear the passage of any ground coffee and/or chaff produced by the grinding mechanism. Additionally, because the water enters the brew chamber through the same passage that the coffee grounds enter from, the water makes contact with the ground coffee substantially immediately upon entry into the brew chamber. The pump may move a set volume of water to the brew chamber via the passage. The set volume of water may be determined based at least in part on the brew size setting received in stage 310. In some embodiments, the brewer may include one or more additional insertion points through which the pumped water may flow into the brew chamber facilitating proper immersion of the grounds.

In some embodiments, the set volume of water may be pumped in two portions. A first portion of the set volume may be pumped to bloom the ground coffee. Blooming the ground coffee comprises contacting the coffee with a relatively small amount of water (e.g., an amount of water that weighs approximately twice the weight of the ground coffee beans). The coffee, when in contact with water, releases carbon dioxide gas. Allowing the carbon dioxide gas to escape the coffee may help to improve the flavor is multiple ways. First, carbon dioxide, when dissolved in water, forms carbonic acid, which has a sour taste. Accordingly, grounds that are not allowed to bloom prior to brewing can produce a more sour coffee than grounds that are bloomed. Second, carbon dioxide can prevent water from making contact with the ground coffee, interfering with the brewing process. Water must contact the coffee grounds to extract the aromatics and oils in the coffee. In embodiments, the blooming process may take approximately 30-40 seconds. After blooming, the second portion of the set volume of water can be pumped into the brew chamber to immerse the coffee grounds in the heated water.

From stage 330, where the water is heated and pumped, the method 300 may proceed to stage 340, where the single serve brewer maintains contact between the water and the ground coffee for a predetermined amount of time. In embodiments, the water may enter the brew chamber and contact the ground coffee, agitating the ground coffee and beginning the brew process. The water is held in the brew chamber for a set time period, based on the brew strength/duration specified in stage 310. In some embodiments, the single serve brewer may display a countdown timer using a display portion of a user input/output panel.

After stage 340, where the coffee brews for the predetermined amount of time, the method 300 may proceed to stage 350, where the single serve brewer releases the brewed coffee from the brew chamber. In particular, upon completion of the set time period, the brewer may determine whether a cup (e.g., a coffee mug, travel mug, or the like) is positioned below the drawdown release valve to receive coffee. If the presence of the cup is not detected by the sensor, the sensor may prevent the drawdown release valve from opening, thereby stopping flow of coffee. Alternatively, if the presence of the cup is detected by the sensor(or if the brewer is not configured with a cup detecting sensor), the single serve brewer may enter a drawdown phase. During drawdown, the controller may cause a drawdown release valve to open, releasing the brewed coffee from the brew chamber. The brewed coffee may flow out through the valve and into a coffee mug or other receptacle. Opening the drawdown release valve may include, for example, activating a solenoid to open the valve.

Following stage 350, the method 300 may optionally proceed to stage 360, where the user may remove the filter and the spent coffee grounds and reset the single serve brewer. In embodiments, the filter can be removed from the brew chamber with the spent coffee grounds. The filter and grounds can be disposed of in any way the user sees fit. For example, the filter and/or grounds may be composted, reducing waste.

Following stage 360, the method 300 may optionally return to stage 310 to begin the brew process for a new single serving of coffee.

### IV. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A single serve coffee brewer comprising:
a user input device configured to receive brew information from a user;
a grinding mechanism configured to grind whole coffee beans, wherein a size of the grind is selected based on the brew information;
a brew chamber comprising:
a first conical section configured to receive and retain, from the grinding mechanism, ground coffee beans,
a filter divider for retaining the ground coffee beans in the first section, and
a second annular section substantially surrounding the first section, the second section being prevented from receiving the ground coffee beans by the filter divider;
a water reservoir;
a heater configured to heat water from the reservoir, the heater being configured to heat the water to a particular temperature selected based on brew information;
a water pump configured to pump a measured amount of heated water from the heater to the brew chamber, wherein the measured amount of heated water is determined based on the brew information; and
a drawdown release valve configured to:
retain the water in the brew chamber for a set duration to brew coffee using the ground coffee beans and the heated water, the set duration being selected based on the brew information, and
responsive to the set duration elapsing, release the brewed coffee from the brewing chamber.

2. The single serve coffee brewer of claim 1, wherein the brew information comprises one or more of:
an indication of a grind size,
an indication of a brewing temperature,
an indication of a brewing duration, or
an indication of a brew size.

3. The single serve coffee brewer of claim 1, wherein the grinding mechanism comprises a conical burr grinder.

4. The single serve coffee brewer of claim 3, wherein the grinding mechanism is configured to receive a quantity of whole coffee beans to brew a single serving of coffee.

5. The single serve coffee brewer of claim 4, further comprising a chute connecting the grinding mechanism to the brew chamber, wherein the ground coffee moves from the grinding mechanism to the chute, and wherein gravity causes the ground coffee to travel through the chute to the brew chamber.

6. The single serve coffee brewer of claim 1, wherein the filter divider is a reusable filter comprising holes that allow water to circulate between the first section and the second section, but prevent the ground coffee from moving between the first section and the second section.

7. The single serve coffee brewer of claim 1, wherein the filter divider is a replaceable paper filter that allows water to circulate between the first section and the second section, but prevents the ground coffee from moving between the first section and the second section.

8. The single serve coffee brewer of claim 7, wherein the filter divider serves as a package for retaining whole coffee beans prior to grinding.

9. The single serve coffee brewer of claim 1, wherein the heater is configured to heat water to a temperature between 190° F. and 210° F.

10. The single serve coffee brewer of claim 1, wherein the brew chamber is thermally insulated to retain heat during a brew process.

11. A method comprising:
receiving, from a user input device, brew information;
responsive to receiving an indication to begin a brewing process:
grinding coffee beans, wherein grinding the coffee beans comprises setting a particular grind size based on the brew information and grinding the coffee beans to the particular grind size;
evacuating the ground coffee beans to a brewing chamber;
pumping heated water to the brewing chamber;
retaining the water in the brewing chamber for a set duration to brew coffee, the set duration being selected based on the brew information; and
responsive to the set duration elapsing, releasing the brewed coffee from the brewing chamber.

12. The method of claim 11, wherein pumping the heated water to the brewing chamber comprises:
pumping a measured amount of water from a reservoir to a water heater;
pumping a first amount of heated water from a water heater to the brewing chamber to contact the ground coffee beans, the first amount of heated water being sufficient to bloom the ground coffee beans; and
after a defined blooming time, pumping a second amount of heated water from the water heater to contact the ground coffee beans within the brewing chamber, wherein the heated water immerses the ground coffee beans, the second amount of heated water being determined based on one or more of the brew information or the first amount of heated water.

13. The method of claim 12, wherein pumping the heated water to the brewing chamber comprises pumping the heated water directly onto the ground coffee beans.

14. The method of claim 11, wherein the brew information comprises one or more of:
an indication of a grind size,
an indication of a brewing temperature,
an indication of a brewing duration, or
an indication of a brew size.

15. The method of claim 11, further comprising inserting a conical filter barrier into the brewing chamber prior to grinding the coffee beans, wherein the filter barrier separates the brewing chamber into a conical section for receiving the ground coffee beans and an annular section that surrounds the conical section that allows for water circulation in the brewing chamber.

16. The method of claim 15, wherein the filter barrier is a replaceable paper filter that allows water to circulate between the conical section and the annular section, but prevents the ground coffee beans from moving between the conical section and the annular section, and wherein the replaceable paper filter serves as a package for retaining whole coffee beans prior to grinding.

17. The method of claim 11, wherein grinding coffee beans comprises grinding a quantity of coffee beans sufficient to brew a single serving of coffee.

18. A single serve coffee brewer comprising:
a user input device configured to receive, from a user:
an indication of a grind size,
an indication of a brewing temperature,
an indication of a brewing duration, and
an indication of a brew size;
a grinding mechanism configured to grind a single serving of whole coffee beans, wherein the size of the grind is selected based on the indication of the grind size;
a brew chamber comprising:
a first conical section configured to receive and retain, from the grinding mechanism, ground coffee beans,
a filter divider for retaining the ground coffee beans in the first section, and
a second annular section substantially surrounding the first section, the second section being prevented from receiving the ground coffee beans by the filter divider, wherein the second annular section allows water to circulate through the brew chamber;
a water reservoir;
a heater configured to heat water from the reservoir, the heater being configured to heat the water to a particular temperature selected based on the indication of the brewing temperature;
a water pump configured to:
pump water from the water reservoir to the heater, and
pump a measured amount of heated water from the heater to the brew chamber, wherein the measured amount of heated water is determined based on the indication of the brew size; and
a drawdown release valve configured to:
retain the water in the brew chamber for a set duration to brew coffee using the ground coffee beans and the heated water, the set duration being selected based on the indication of the brewing duration, and
responsive to the set duration elapsing, release the brewed coffee from the brewing chamber.

19. The single serve coffee brewer of claim 18, wherein the filter divider is a replaceable paper filter that allows water to circulate between the first section and the second section, but prevents the ground coffee from moving between the first section and the second section.

20. The single serve coffee brewer of claim 19, wherein the filter divider serves as a package for retaining the whole coffee beans prior to grinding.
